(19) United States
(12) Patent Application Publication
(10) Pub. No.: US 2007/0007217 A1
(43) Pub. Date: Jan. 11, 2007

(54) Energy efficient, UV water disinfection systems and methods thereof

(75) Inventors: Ali Ogut, Pittsford, NY (US); Jian Yu, Beijing (CN); Wei Yang, Elmwood Park, NJ (US)

Correspondence Address: NIXON PEABODY LLP - PATENT GROUP, CLINTON SQUARE, P.O. BOX 31051, ROCHESTER, NY, 14603-1051, US

(73) Assignee: Rochester Institute of Technology, Rochester, NY (US)

(21) Appl. No.: 11/477,687

(22) Filed: Jun. 29, 2006

Related U.S. Application Data
(60) Provisional application No. 60/696,973, filed on Jul. 6, 2005.

(51) Int. Cl. C02F 1/32

(52) U.S. Cl. 210/748; 250/436

(57) ABSTRACT

A system and a method for disinfecting a fluid includes a vessel with at least one passage having at least an inlet and an outlet and one or more radiation sources. The one or more radiation sources are positioned about at least a portion of a perimeter of the passage in the vessel to direct radiation into a fluid in the passage of the vessel to at least partially disinfect the fluid.

This application claims the benefit of U.S. Provisional Patent Application Serial No. 60/696,973, filed Jul. 6, 2005, which is hereby incorporated by reference in its entirety.

### FIELD OF THE INVENTION

The present invention generally relates to disinfection systems and methods and, more particularly, to energy efficient, circumferential, ultraviolet (UV) radiation disinfection systems and methods thereof.

### BACKGROUND

UV is light energy between about 100 nm and 400 nm wavelength, between the X-ray portion of the spectrum and the visible portion. In most UV disinfection applications, the short wave portion of the UV spectrum is used. This portion is referred to as UV-C and spans from about 200 nm to 280 nm.

UV is capable of destroying pathogens such as bacteria, viruses, and protozoa that can cause a variety of illnesses, such as amoebic dysentery, cholera, polio, and typhoid fever. UV radiation works by causing the formation of chemical bonds in cellular DNA. The exposure thus interrupts normal DNA replication and organisms are killed or rendered inactive. UV disinfection of water is currently used in drinking water, wastewater, and aquaculture industries. The development of UV technology for use in these industries has defined the operational parameters that influence the effectiveness of UV in water disinfection systems.

UV-C technology is recognized by the EPA as one of four approved methods of sterilizing water, and is preferable over the other three approved methods, chlorine, iodine, and distillation, because of the cost of treatment and effectiveness of UV-C. More specifically, UV-C technology works almost instantaneously, leaving no residuals in the water. Additionally, UV-C technology is fast, does not alter pH, taste, and carries no risk of overdose. Further, UV-C technology is a non-chemical approach for microbial control and produces no toxic by-products. UV-C technology is now accepted by both the EPA and FDA as a safe, effective method of water disinfection. UV-C technology is also a “World Health Organization” approved method of disinfecting water.

The degree of microbial destruction is a function of both the time and intensity of the radiation to which a given microorganism is exposed. A short exposure time at high intensity is as effective as a long exposure time at low intensity provided the product of the exposure time and intensity, which is known as UV dosage, remains the same. The intensity and exposure time is governed by the geometry and the hydrodynamics of the UV system. The UV system is designed such that the lowest dose received by any of the water is sufficient to achieve the desired effect on microorganisms. The dosage is normally expressed in microwatt-seconds/sq cm. UV irradiation is effective against bacteria at dosage levels of 3 to 30 mJ/cm² and against viruses at 30 to 100 mJ/cm². In addition, recent studies have shown that UV radiation is also effective against of Giardia and Cryptosporidium, causing internal damage and eliminating their threat, even when they are exposed to dosage levels in the tens of mJ/cm².

Referring to FIGS. 1A and 1B, an example of a typical, prior, commercial UV disinfection system is illustrated. In this design, the straight UV bulb is located at the center of the pipe and the water flows through the annular space. The UV bulb radius is R_{B} (m), water pipe radius is R_{P} (m), and the length of the disinfector is L (m). The water volumetric flow rate is G (m³/s).

In this typical commercial UV treatment system, water is flushed through a reactor vessel, where a UV lamp located in the center of the pipe irradiates the flowing water. In this system, the distribution of the UV dose is extremely non-uniform so that at distances away from the UV light source, the UV dosage may be too low to kill microorganisms. As a result, these prior commercial UV treatment systems, require more power and a very high power bulb at the center of the pipe to meet the minimum dosage requirement at the pipe surface for effective treatment of the water. Some prior UV treatment systems have added baffles to the reactor vessel to help generate radial mixing for a more uniform exposure of the water to UV, but they add to the cost and complexity of the unit.

### SUMMARY

A disinfection system in accordance with embodiments of the present invention includes a vessel with at least one passage having at least an inlet and an outlet and one or more radiation sources. The one or more radiation sources are positioned about at least a portion of a perimeter of the passage in the vessel to at least partially direct radiation towards the at least one passage.

A method for making a disinfection system in accordance with other embodiments of the present invention includes providing a vessel with at least one passage having at least an inlet and an outlet. One or more radiation sources are positioned about at least a portion of a perimeter of the passage in the vessel to at least partially direct radiation towards the at least one passage.

A method for disinfecting in accordance with other embodiments of the present invention includes directing a fluid through a vessel with at least one passage, the passage in the vessel having at least an inlet and an outlet. Radiation from one or more radiation sources positioned about at least a portion of a perimeter of the passage in the vessel is directed into the fluid to at least partially disinfect the fluid. The at least partially disinfected water is output through the output in the vessel.

The present invention provides an effective and energy efficient ultraviolet (UV) radiation disinfection system and method. With this design the present invention has a more uniform UV dose through the tube and, even with lower power bulbs, the UV dosage is sufficient to kill the microorganisms needed to properly disinfect water than was possible with prior disinfection units. Additionally, the ability to use lower power bulbs saves energy and makes the disinfection system more compact with small footprint and thus easier to install than prior disinfection units.

### BRIEF DESCRIPTION OF THE DRAWINGS

FIG. 1A is a perspective view of a prior UV disinfection system;

FIG. 1B is an end view of the prior UV disinfection system shown in FIG. 1A;

FIG. 2 is a perspective view of a disinfection system in accordance with embodiments of the present invention with a portion of the reflector system removed;

FIG. 3A is a side, cross-sectional view of the disinfection system shown in FIG. 2;

FIG. 3B is an end, cross-sectional view of the disinfection system shown in FIG. 2;

FIG. 4A is a side view of a reflector system of the disinfection system shown in FIG. 2;

FIG. 4B is an end, cross-sectional view of the reflector system shown in FIG. 4A;

FIG. 5 is a graph of test results of UV dosage versus UV input power for a prior commercial UV disinfection system and three exemplary embodiments of the disinfection system in accordance with the present invention; and

FIG. 6 is a partial perspective and partial cross-sectional view of another disinfection system in accordance with other embodiments of the present invention.

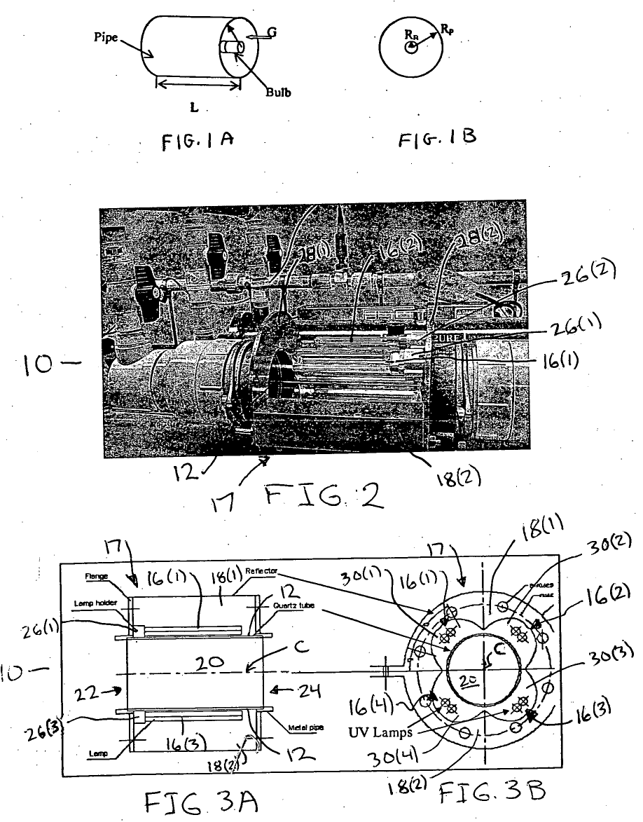

### DETAILED DESCRIPTION

A fluid disinfection system 10(1) in accordance with embodiments of the present invention is illustrated in FIGS. 2-4B. The fluid disinfection system 10(1) includes a tube 12, UV light sources 16(1)-16(4), and a reflector system 17, although the disinfection system 10(1) can comprise other numbers and types of components in other configurations. The present invention provides a number of advantages including providing an effective and energy efficient ultraviolet radiation disinfection system and method.

Referring to FIGS. 2A-4B, the tube 12 defines a passage 20 with an inlet 22 and an outlet 24 through which a fluid to be disinfected can flow, although other types and numbers of conduits in other configurations can be used. The tube 12 is made out of quartz and is substantially transparent, although the tube 12 can be made out of another material or materials that is/are at least partially transmissive to radiation used to treat the fluid flowing through the tube 12. The ends of the tube 12 are secured between ends of water pipes, such as in a water treatment facility or a home where a fluid is to be disinfected, although other manners for connecting the disinfection system 10(1) can be used.

The UV light sources 16(1)-16(4) when engaged each output the short wave portion of the UV spectrum referred to as UV-C which spans from about 200 nm to about 280 nm, although other numbers and types of light sources which output radiation at other spectrums to disinfect a fluid can be used. In these embodiments, the UV light sources 16(1)-16(4) are each 5.5 inches long and have an elongated U-shape, although each of the UV light sources 16(1)-16(4) could have other dimensions and shapes.

The UV light sources 16(1)-16(4) are positioned and spaced a substantially equidistance apart around an outer perimeter of the tube 12 and are positioned to extend along in a direction of the fluid flow to maximize exposure of the fluid to radiation, although other spacing and configurations can be used. The UV light sources 16(1)-16(4) are positioned outside of the tube 12 so that they do not disturb the flow of the fluid in the passage 20 and also so the UV light sources 16(1)-16(4) are more easily accessible for replacement and repair, although other locations for one or more of the UV light sources 16(1)-16(4) could be used, such as having one or more of the UV light sources positioned inside the passage 20 of tube 12.

The UV light sources 16(1)-16(4) are each respectively installed and electrically coupled to a lamp holder system which is coupled to a power source that provides power to UV light sources 16(l)-16(4) in manners well known to those of ordinary skill in the art. In these embodiments, lamp holder systems 26(1)-26(3) which are each used to receive and electrically couple to one of the UV light sources 16(1)-16(3) are illustrated. The lamp holder system for UV light source 16(4) is not shown, but is identical to lamp holder systems 26(1)-26(3). The lamp holder systems are secured to a flange 28(2), although the lamp holder systems could be secured in other manners and locations.

The intensity I of the UV light for these embodiments can be shown to be:

$$I = \frac{{P}_{B}}{2 π rL} {ⅇ}^{- 2.3 ( {R}_{B} - r )}$$

And the dosage for these embodiment can be shown to be:

$$D = \frac{{P}_{B} {R}_{B}^{2}}{2 rG} {ⅇ}^{- 2.3 ( {R}_{B} - r )}$$

where P_{B} is UV lamp power, Watts, r is distance from pipe center in m, R_{B} is the radius of the UV bulb radius in m, R_{P} is the radius of the water pipe in m, L is the length of the disinfector is L in m, and G is the water volumetric flow rate in m³/s.

According to this equation the instantaneous UV intensity is minimum at the bulb surface for each of the UV light sources 16(1)-16(4), and maximum at the center C of the tube 12. In these embodiments, the intensity increases toward the pipe center C due to decreasing surface area. As a result a lower power bulb for each of the UV light sources 16(1)-16(4) will be sufficient to accomplish effective results, even at the center C of tube 12 which is the farthest point from the bulb surface for each of the UV light sources 16(1)-16(4). Using lower power UV bulbs for each of the UV light sources 16(1)-16(4) results in energy savings and also makes the design of the disinfection system 10(1) more compact and easily installed.

Referring to FIGS. 2-4B, the reflector system 17 includes halves 18(1)-18(2) which when in position about the UV light sources 16(1)-16(4) are secured together with bolts, although the reflector system 17 could comprise other numbers and types of sections which are secured in other manners and other types of reflectors could be used. The reflector system 17 is secured to the ends of the water pipes on both sides in the disinfection system 10(1) with flanges 28(1) and 28(2), although the reflector 17 can be secured in other manners. The reflector system 17 is made of aluminum and is about eight inches long, although the reflector system 17 can be made of other reflective materials, have other dimensions and be secured in other manners. The reflector 17 is used to reflect UV light towards the center of the tube 12 to help reduce the power requirements for the UV light sources 16(1)-16(4) and to generate a more uniform UV light distribution through the fluid.

The reflector system 17 includes recessed portions 30(1)-30(4) in which each of the UV light sources 16(1)-16(4) are positioned to assist in the reflection of the UV light towards the center C of the tube 12, although other numbers and types of recessed portions can be used and the recessed portions are optional. The recessed portions 30(1)-30(4) each have an arc-shape which helps to reflect the UV light towards the center C of the tube 12, although the recessed portions 30(1)-30(4) could have other shapes and configurations.

Referring to FIG. 6, a perspective view of another disinfection system 10(2) in accordance with embodiments of the present invention is illustrated. This embodiment is identical to the embodiment shown in FIGS. 2-4B, except as set forth herein. In this embodiment, the UV light source 16(5) is a circular shaped bulb which is installed around the tube 12, although other numbers and types of UV light sources with other shapes can be used, such as an elongated UV light source where the elongated portion of the UV light source extends in a direction at least partially around the perimeter of the passage 20 in tube 12. The disinfection system 10(2) also includes a hemispherical reflector 32 which is secured over an outer portion of the UV light source 16(5) and is positioned to reflect the light toward the center C of the tube 12.

The operation of the disinfection system 10(1) will now be described with reference to FIGS. 2-4B. The disinfection system 10(1) is fluidly connected between ends of a pipe carrying a fluid to be disinfected, such as water. To begin the disinfection process, a fluid is introduced into the passage 20 via the inlet 22.

Meanwhile, the UV light sources 16(1)-16(4) which extend along the direction of the flow of the fluid are turned on to direct UV light between about 200 nm to about 280 nm into the fluid, although radiation at other wavelengths could be introduced. With the configuration of the present invention, the UV intensity is at a minimum at the bulb surface for each of the UV light sources 16(1)-16(4) and is at a maximum at the center C of the tube 12 which helps to reduce the UV output requirements for each of the UV light sources 16(1)-16(4). Additionally, this configuration helps to more uniformly distribute UV light through the fluid to effectively kills microorganisms, such as bacteria, viruses and protozoa, in the fluid.

The reflector 17 helps to reflect the UV light output by the UV light sources 16(1)-16(4) towards the center C which further helps to reduce the UV output requirements for each of the UV light sources 16(1)-16(4) and kill microorganisms in the fluid. The reflection of the UV light by reflector 17 is further enhanced by the recessed portions 30(1)-30(4) in the halves 18(1)-18(2) of the reflector system 17 which each have an arc-shape that assists in more effectively reflecting the UV light towards the center C of the tube 12 to disinfect the fluid. Once the fluid has passed the UV light sources 16(1)-16(4), the disinfected fluid is output from the passage 20 in the tube 12 via the outlet 24 into the end of the other pipe.

The operation of the disinfection system 10(2) shown in FIG. 6 is the same as the operation for the disinfection system 10(1) shown in FIGS. 2-4B. except as set forth herein. In this embodiment, the fluid passes the circular-shaped UV light source 16(5) which directs UV light towards the center of the tube 12. With this configuration of the present invention, the UV intensity is minimum at the bulb surface for the UV light source 16(5) and is at a maximum at the center C of the tube 12 which also helps to reduce the UV output requirements for the UV light sources 16(5). Additionally, this configuration helps to more uniformly distribute UV light through the fluid to effectively kills microorganisms, such as bacteria, viruses and protozoa, in the fluid. The hemispherical-shaped reflector 32 reflects UV light from the UV light source 16(5) towards the center C if the tube 12 to further assist with the disinfection of the fluid.

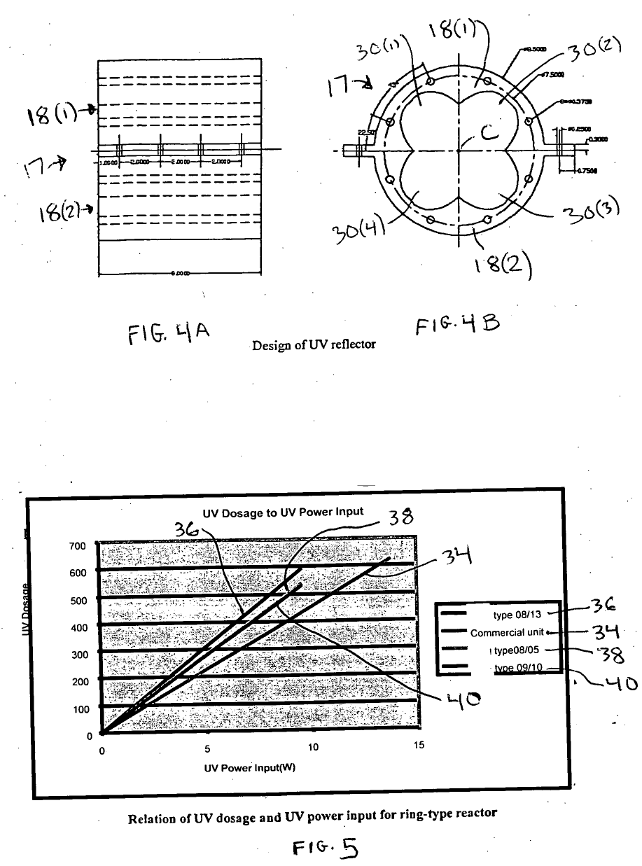

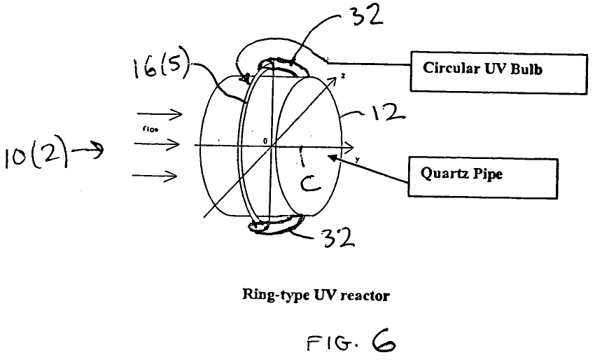

By way of example only, a graph of test results of a disinfection system in accordance with embodiments of the present invention and a prior commercial unit are illustrated in FIG. 5. Based on the average dosage comparison, the test results showed that the disinfection system in accordance with embodiments of the present invention produces 21% higher dosage compared with the prior commercial unit. This higher rate of dosage delivery can be converted to an equivalent amount of energy savings.

Accordingly, the present invention provides an effective and energy efficient ultraviolet radiation disinfection system and method. With the lower power bulbs for the UV light sources, the present invention gets the same results as prior commercial disinfection systems, but with substantial energy savings. Additionally, when the present invention is compared with the prior commercial disinfection units the present invention has a smaller foot print for installation.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A disinfection system comprising:
a vessel with at least one passage; and
one or more radiation sources positioned about at least a portion of a perimeter of the passage in the vessel to at least partially direct radiation towards the at least one passage.

2. The system as set forth in claim 1 wherein the one or more radiation sources comprises a plurality of radiation sources which are spaced about the perimeter of the passage and outside the vessel.

3. The system as set forth in claim 2 wherein the plurality of radiation sources are each spaced a substantially equidistant apart about the perimeter.

4. The system as set forth in claim 2 wherein the plurality of radiation sources are positioned so an intensity of radiation from each of the plurality of radiation sources is at a minimum at a surface of each of the plurality of radiation sources and is at a maximum at a location spaced away from each of the plurality of radiation sources.

5. The system as set forth in claim 4 wherein the location where the intensity is at a maximum is substantially at a center of the passage in the vessel.

6. The system as set forth in claim 1 wherein the one or more radiation sources comprises at least one radiation source which is elongated and the elongated portion of the at least one radiation source extends in a direction at least partially around the perimeter of the passage in the vessel.

7. The system as set forth in claim 6 wherein the at least one radiation source comprises a ring-shaped radiation source which is outside of the vessel.

8. The system as set forth in claim 1 wherein the vessel comprises a conduit which is at least partially transmissive to radiation from the one or more radiation sources and wherein the one or more radiation sources are located outside of the conduit.

9. The system as set forth in claim 8 wherein the conduit is made of a substantially transparent material.

10. The system as set forth in claim 1 further comprising at least one reflector which is positioned around one or more of the radiation sources to at least partially reflect radiation towards the passage in the vessel.

11. The system as set forth in claim 10 further comprising one or more recessed portions in the at least one reflector, wherein one or more of the radiation sources are positioned in the one or more recessed portions.

12. The system as set forth in claim 6 further comprising one or more reflectors with a hemispherical cross-sectional shape which are positioned at least partially around the at least one radiation source to reflect radiation towards a center of the passage in the vessel.

13. The system as set forth in claim 1 wherein at least one of the one or more radiation source is an ultraviolet light source.

14. A method for making a disinfection system, the method comprising:
providing a vessel with at least one passage having at least an inlet and an outlet; and
positioning one or more radiation sources about at least a portion of a perimeter of the passage in the vessel to at least partially direct radiation towards the at least one passage.

15. The method as set forth in claim 14 wherein the positioning one or more radiation sources further comprises positioning a plurality of radiation sources which are spaced about the perimeter of the passage in the vessel and outside the vessel.

16. The method as set forth in claim 15 wherein the plurality of radiation sources are each spaced a substantially equidistant apart about the perimeter.

17. The method as set forth in claim 15 wherein the positioning one or more radiation sources further comprises positioning the plurality of radiation sources so an intensity of radiation from each of the plurality of radiation sources is at a minimum at a surface of each of the plurality of radiation sources and is at a maximum at a location spaced away from each of the plurality of radiation sources.

18. The method as set forth in claim 17 wherein the location where the intensity is at a maximum is substantially at a center of the passage in the vessel.

19. The method as set forth in claim 14 wherein the positioning one or more radiation sources further comprises positioning at least one radiation source which is elongated so the elongated portion of the at least one radiation source extends in a direction at least partially around the perimeter of the passage in the vessel.

20. The method as set forth in claim 19 wherein the at least one radiation source comprises a ring-shaped radiation source which is outside of the vessel.

21. The method as set forth in claim 14 wherein the providing the vessel further comprises providing a conduit which is at least partially transmissive to radiation from the one or more radiation sources in the passage in the vessel, wherein the positioning one or more radiation sources further comprises positioning the one or more radiation sources outside of the conduit.

22. The method as set forth in claim 21 wherein the conduit is made of a substantially transparent material.

23. The method as set forth in claim 14 further comprising positioning at least one reflector around one or more of the radiation sources to at least partially reflect radiation towards the passage in the vessel.

24. The method as set forth in claim 23 further comprising positioning one or more of the radiation sources in one or more recessed portions in the at least one reflector.

25. The method as set forth in claim 19 further comprising placing one or more reflectors with a hemispherical cross-sectional shape around the at least one radiation source to reflect radiation towards a center of the passage in the vessel.

26. The method as set forth in claim 14 wherein at least one of the one or more radiation source is an ultraviolet light source.

27. A method for disinfecting, the method comprising:
directing a fluid through a vessel with at least one passage, the passage in the vessel having at least an inlet and an outlet; and
directing radiation from one or more radiation sources positioned about at least a portion of a perimeter of the passage in the vessel into the fluid, wherein the radiation at least partially disinfects the fluid;
outputting the at least partially disinfected water through the output in the vessel.

28. The method as set forth in claim 27 wherein the directing radiation from one or more radiation sources further comprises directing radiation from a plurality of radiation sources which are spaced about the perimeter of the passage in the vessel into the fluid and outside of the vessel wherein the radiation at least partially disinfects the fluid.

29. The method as set forth in claim 28 wherein the plurality of radiation sources are each spaced a substantially equidistant apart about the perimeter.

30. The method as set forth in claim 28 wherein the directing radiation from a plurality of radiation sources further comprises directing the radiation from the plurality of radiation sources so an intensity of radiation from each of the plurality of radiation sources is at a minimum at a surface of each of the plurality of radiation sources and is at a maximum at a location spaced away from each of the plurality of radiation sources.

31. The method as set forth in claim 30 wherein the location where the intensity is at a maximum is substantially at a center of the passage in the vessel.

32. The method as set forth in claim 27 wherein the directing radiation from one or more radiation sources further comprise directing radiation from at least one radiation source which is elongated and the elongated portion of the at least one radiation source extends in a direction at least partially around the perimeter of the passage in the vessel.

33. The method as set forth in claim 32 wherein the at least one radiation source comprises a ring-shaped radiation source which is outside of the vessel.

34. The method as set forth in claim 27 wherein the directing a fluid through a vessel with at least one passage further comprises directing the fluid through a conduit in the passage in the vessel, the conduit is at least partially transmissive to radiation from the one or more radiation sources and the one or more radiation sources are located outside of the conduit.

35. The method as set forth in claim 34 wherein the conduit is made of a substantially transparent material.

36. The method as set forth in claim 27 further comprising reflecting the radiation into the fluid with at least one reflector positioned around one or more of the radiation sources.

37. The method as set forth in claim 36 further comprising positioning one or more of the radiation sources in one or more recessed portions in the at least one reflector.

38. The method as set forth in claim 32 further comprising reflecting the radiation with one or more reflectors with a hemispherical cross-sectional shape which are positioned at least partially around the at least one radiation source towards a center of the passage in the vessel.

39. The method as set forth in claim 27 wherein the radiation is ultraviolet radiation.
